(19) United States
(12) Patent Application Publication
(10) Pub. No.: US 2026/0172649 A1
(43) Pub. Date: Jun. 18, 2026

(54) SYSTEMS AND METHODS FOR AUDIO WATERMARKING

(71) Applicant: Comcast Cable Communications, LLC, Philadelphia, PA (US)

(72) Inventors: Matthew EBERSVILLER, EVERGREEN, CO (US); Jonathan KIRKOVICH, PARKER, CO (US); Ryan MCMURRAY, ARVADA, CO (US)

(21) Appl. No.: 18/979,146

(22) Filed: Dec. 12, 2024

(51) Int. Cl. H04N 21/8358; H04N 21/233; H04N 21/24

(52) U.S. Cl. CPC H04N 21/8358; H04N 21/233; H04N 21/2407

(57) ABSTRACT

Methods and systems are described for providing content. A network of devices may be configured to add encoded information to the audio of content received by the network devices. The encoded information may comprise an identifier of the device adding the encoded information, account information if the device is a user device, metadata, and/or other information. The audio portion of the content may be analyzed to determine the last authorized device to have the content before an unauthorized use.

### BACKGROUND

Content distribution has improved with the digitization of modern content. This has allowed content distribution platforms to provide content for streaming via the internet through a variety of services to a large variety of devices. However, the digitization of content may allow people to steal or share the content with unauthorized users or unauthorized devices. Thus, there is a need for more sophisticated techniques for determining and preventing the unauthorized sharing of content.

### SUMMARY

Methods and systems for tracking a content item are disclosed. Multiple devices within a network infrastructure may receive a content item (e.g., a show, movie, live stream, or other media). Each device may add information to the audio portion of the content. The information may comprise a unique identifier associated with the device adding the identifier. The information may be added as an encoded audio signal inaudible to a human. The information may be used for purposes of authorization, determining where unauthorized sharing occurs in the network, and/or the like. For example, if the content item is eventually accessed by a user device, the device may determine, based on at least a portion of these encoded audio signals, whether it is authorized to access the content. If the content is later discovered on an unauthorized device, an analysis of the audio portion may reveal the last authorized device that received the content. For example, a user device (e.g., mobile device, set top box, streaming device) may add an identifier associated with the user device and/or user account. If the user shares the content item with someone else who is unauthorized, then the content item may be analyzed to determine the user account that was associated with the unauthorized sharing. Actions may be taken, such as suspending the user account, based on identifying the user account by analyzing the audio.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 shows an example system.

FIG. 2A shows an example system.

FIG. 2B shows an example process.

FIG. 2C shows an example audio signal.

FIG. 3 shows an example method.

FIG. 4 shows an example method.

FIG. 5 shows an example method.

FIG. 6 is a block diagram illustrating an example computing device.

### DETAILED DESCRIPTION OF ILLUSTRATIVE EMBODIMENTS

Streaming content has become a common method for users to access content, such as audio, videos, shows, programs, movies, and/or the like. Content providers may grant access to content via subscriptions or the like. Users are able to gain access to content via purchasing a subscription or individually purchasing access to the content. However, some users may abuse access to the content and share with unauthorized people. Content may be stolen from content providers networks or services by users who abuse access. This may be a costly problem to content providers. As such, it may be beneficial for content providers to have a method or system to monitor where unauthorized content may originate.

At multiple points in the content workflow (e.g., video workflow), from origination though customer playout, various identifying information can be embedded into inaudible audio frequencies. Identifiers such as content creator/provider, content aggregator, air date, transcode information, MSO, customer player id, customer MAC address, etc. can all be embedded into the audio stream, but at inaudible frequencies and/or inaudible volume levels. Content marked this way can then be identified on unauthorized copies. By identifying data added to the content at different points in the workflow, pinpointing the location of leaks for copy-protected assets becomes possible. Additionally, by adding a customer identifier at playout via the player software, specific nefarious actors can be identified.

An automated tool that scans known piracy sites can be created and take small samples of audio in order to scan for copyright infringements. This tool may be used to notify network providers, service provides, content providers, or any number of touch points. This tool may be used to automatically halt service for a customer identified as being the source of piracy or copyright infringement.

The identifying information may be embedded in the audio at various points during the process of preparing and delivering content to a user. For example, the identifying information may be embedded prior to transcoding content and/or during transcoding of content in preparation for delivery of the content to one or more users. In some scenarios, the identifying information may be added directly to the original audio of the content. In other scenarios, the identifying information may be added to a separate track that may be combined (e.g., prior to playback or during playback) with the original audio. For example, a post-transcode step (e.g., performed at a user’s playback device) may comprise combining the original audio with a separate audio (e.g., or audio track) generated for the user that may include identifying information associated with the user (e.g., or associated with a playback session associated with the user).

The present disclosure relates to systems and methods for monitoring which devices in a network receive a content item. The content item may comprise an audio portion and, in some cases, a video portion. The audio portion may include a plurality of audio signals. The plurality of audio signals may include one or more encoded audio signals that may correspond to a plurality of identifiers. Each of the plurality of identifiers may identify a corresponding network device of a plurality of network devices that may have each inserted one or more encoded audio signals to the audio portion of a content item. The one or more encoded audio signals may be audio signals at one or more frequencies in a human inaudible frequency range. A comparison of a last device associated with a network device to insert an identifier from which the user device received the content item may be utilized to determine (e.g., verify) or source of unauthorized use or to determine whether to authorize a device having the content to output the content.

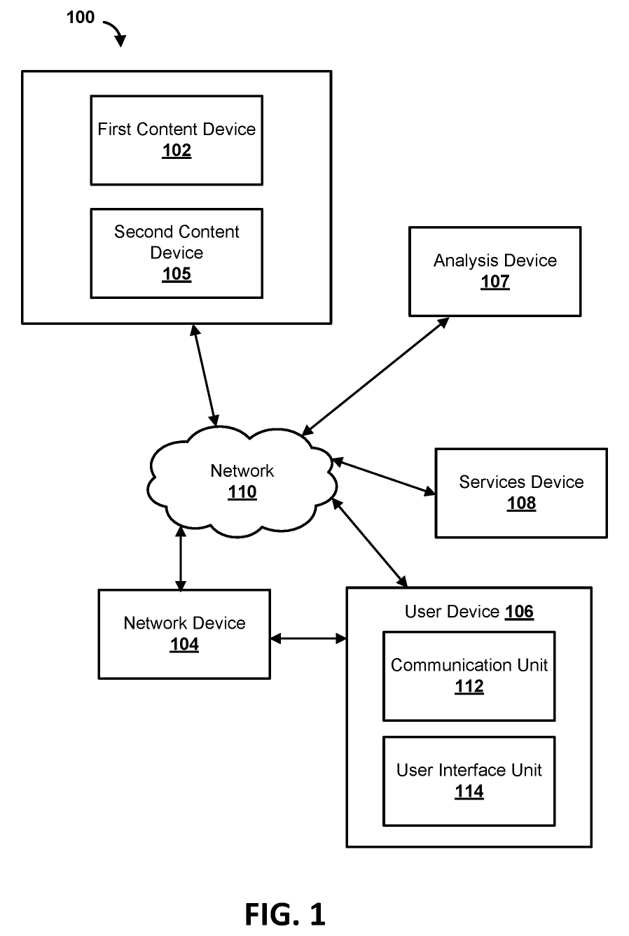

FIG. 1 shows a block diagram of an example system 100 for delivery, access, and/or tracking of content. The system 100 may comprise a network device 104 (e.g., gateway device, a termination system, a cable modem termination system, a network node, switch, router, or combination thereof), a user device 106, a services device 108 (e.g., an application device, application server), or a combination thereof. The system 100 may further comprise one or more content devices (e.g., content server, edge device), such as a first content device 102, and a second content device 105. The one or more content devices 102, 105, the network device 104, the user device 106, the analysis device 107, and/or the services device 108 may each be implemented as one or more computing devices. Any device disclosed herein may be implemented using one or more computing nodes, such as virtual machines, executed on a single device and/or multiple devices.

The first content device 102, the second content device 105, the network device 104, the user device 106, the analysis device 107, and/or the service device 108 may be communicatively coupled via one or more networks, such as network 110 (e.g., a wide area network). The network 110 may comprise a content distribution and/or access network. The network 110 may facilitate communication via one or more communication protocols. The network 110 may comprise fiber, cable, a combination thereof. The network 110 may comprise wired links, wireless links, a combination thereof, and/or the like. The network 110 may comprise routers, switches, nodes, gateways, servers, modems, and/or the like.

The services device 108 may be configured to provide one or more services, such as account services, application services, network services, content services, or a combination thereof. The services device 108 may comprise services for one or more applications on the user device 106. The services device 108 may generate application data associated with the one or more application services. The application data may comprise data for a user interface, data to update a user interface, data for an application session associated with the user device 106, and/or the like.

The services device 108 may be configured to determine to send information (e.g., configuration settings, notifications, information about the premises) to the user device 106, the network device 104, or a combination thereof. The one or more content devices 102, 105 may comprise information rules associating various values, patterns, account information, and/or the like with corresponding information. The information may be sent to the user device 106 based on the information rule being triggered and/or satisfied. The information may comprise a configuration setting of the network device 104 and/or the user device 106.

The user device 106 may comprise a computing device, a smart device (e.g., smart glasses, smart watch, smart phone), a mobile device, a tablet, a computing station, a laptop, a digital streaming device, a set-top box, a streaming stick, a television, and/or the like. In some scenarios, a user may have multiple user devices, such as a mobile phone, a smart watch, smart glasses, a combination thereof, and/or the like. The user device 106 may be configured to communicate with one or more content devices (e.g., the first content device 102, or the second content device 105), the network device 104, the analysis device 107, and/or the like.

The user device 106 may be configured to output a user interface. The user interface (e.g., user interface unit 114) may be output via the user interface via an application, service, and/or the like, such as a content browser. The user interface may receive application data from the services device 108. The application data may be processed by the user device 106 to cause display of the user interface. The user interface may be displayed on a display of the user device 106 (e.g., or controlled by the user device 106). The display may comprise a television, screen, monitor, projector, and/or the like. The user interface may comprise a content management application (e.g., for accessing video, audio, gaming, and/or other media), a smart assistant application, a virtual assistant application, a premises security application, network services application, or a combination thereof. The user interface may be configured to output content via a content browser. The user interface may be configured to provide a plurality of channels (e.g., video channels), streams, video on demand items, audio items, and/or the like. The user interface may be configured to allow a user to configure settings associated with the network device 104.

The network device 104 may comprise a computing device, a gateway device, an access point (e.g., wireless access point), a router, a modem, device controller (e.g., automation controller, security controller, premises health controller, content device controller) a combination thereof, and/or the like. The network device 104 may be configured to communicate using network 110. The network device 104 may be configured to implement one or more services associated with the services device 108, such as a content service, a premises service, a voice-controlled service, an automation service, a security service, a health monitoring service, or a combination thereof.

The services device 108 may be configured to determine content, such as a content item comprising a plurality of frames. The content item may be determined (e.g., accessed, located) based on a request from a user device 106. The content item may comprise an audio portion and a video portion. The services device 108 may comprise one or more of a conditioning device, a transcoder, a packager, or the like to prepare a content item for user consumption via a user device 106. The services device 108 may be configured to insert one or more identifiers to the audio portion of a content item. The insertion of one or more identifiers may comprise one or more encoded audio signals. Inserting the one or more identifiers may comprise decoding the content item, adding the one or more identifiers to the audio portion of the content item, and encoding the content item comprising the one or more identifiers. The one or more identifiers may identify a history of network devices that may have received the content item. The one or more identifiers may provide information related to the network device that may have previously received the content item. For example, if the content was received by the first content device 102, a first identifier one or more identifiers may be an identifier associated with the first content device 102. If the content was received by the second content device 105, a second identifier of the one or more identifiers may be an identifier associated with the second content device 105. The one or more identifiers may comprise a third identifier associated with the services devices. In some scenarios, the services device 108 may insert the first identifier and/or the second identifier, but in other scenarios, the first identifier and/or the second identifier may already be inserted as audio signals in the content item prior to the services device 108 receiving the content item. For example, the first content device 102 may insert the first identifier (e.g., as a first audio signal). The second content device 105 may insert the second identifier (e.g., as a second audio signal). The services device 108 may add the third identifier by adding an additional audio signal.

The services device 108 may insert other information in addition to or instead of the one or more identifiers. For example, the information may comprise metadata, the type of network device (e.g., transcoder, packager, or the like), sidecar metadata, ratings, information about the content item, parental advisory ratings, or the like. The combination of information may be used to uniquely identifier a device, a path of the content item, and/or the like. The information may be used to provide additional services associated with the content item, such as providing information about the content item to a user.

It should be noted that adding the one or more identifiers (e.g., and other information) may include adding one or more identifiers (e.g., and other information) a single time or multiple times. The information and/or one or more identifiers may be repeated or span the length of the audio portion associated with the content item. The one or more identifiers associated with one or more encoded audio signals may be of a human inaudible frequency such that the one or more identifiers may not be heard by a user associated with a user device 106. The one or more identifiers may be of the same frequency that are within a human inaudible frequency range. The one or more identifiers may be of the different frequencies that are within a human inaudible frequency range. The one or more identifiers and/or other information may be inserted such that an order is preserved regarding which device received the content at which time point. For example, the first identifier and second identifier may be encoded in a manner that indicates that the first content device 102 received the content item before the second content device. Similarly, the third identifier may be encoded in a manner that that indicates that the services device 108 received the content item after the second device 105.

The one or more identifiers (e.g., and other information) may be used to generate an audio signal using an audio generation process. The audio generation process may apply any available process to generate a human inaudible signal. The audio generation process may comprise one or types of modulation (e.g., amplitude modulation, frequency modulation, phase modulation) to modulate an audio signal to encode the one or more identifiers (e.g., and other information). The audio generation process may generate an audio signal that may be harmoniously joined with the current audio signals of the content item. For example, various multiplexing techniques may be used to ensure that information and/or identifiers from one device do not cause corruption of information and/or identifiers from another device.

The services device 108 may be configured to send the content item comprising the one or more identifiers. The content item comprising the one or more identifiers may be sent to the user device 106. The user device 106 may cause playback of the content item. The user device 106 may be unaware of the one or more encoded audio signals associated with the one or more identifiers. For example, the user device 106 may cause playback without checking for the one or more identifiers. In some scenarios, the user device 106 may be configured to verify whether the content comprises one or more identifiers. For example, the user device 106 may perform any of the functions of the analysis device 107 described further herein. If the user device 106 is unable to verify the network device that receives the content item to the one or more identifiers, then the user device 106 may stop playback and/or provide a notification to the user, the services device 108, the analysis device 107, the content device 102, and/or the like.

The analysis device 107 may be configured to analyze content items. The analysis device 107 may analyze the audio portion associated with the content item. The service device 108 and/or user device 106 may send a content item to the analysis device 107. The analysis device 107 may be configured to determine a plurality of network devices associated with the one or more identifiers inserted into the audio portion of the content item. Each network device that may receive the content item may insert one or more identifiers to the audio portion of the content item. The analysis device 107 may be configured to determine a network device associated with the content item based on information encoded in one or more encoded audio signals associated with the one or more identifiers. A network device may be associated with a particular identifier of one or more identifiers associated with the audio portion of the content item. The analysis device 107 may be configured to receive the audio portion as a waveform, where the analysis device may convert (e.g., decode) the waveform to a string of characters (e.g., binary text) which may include information or data associated with a history of the content item. The history of the content item may include one or more of: previous network devices that have received the content item, metadata, sidecar metadata, text information, content ratings, information about the video, parental advisory ratings, or any other suitable data. The analysis device 107 may be configured to analyze the audio portion to determine a location of the encoded audio signal in the audio portion.

Analysis device 107 may be configured to send an indication of an association of the network device with unauthorized access to the content item, based on the determining of the network device. The indication of the user account may be sent to one or more of a computing device (e.g., user device 106) or any other suitable device, such as a device (e.g., analysis device 107, or other device) hosting a content piracy user interface managed by a services provider. The computing device that received the indication of the user account may be configured to output, based on the determined network device, an indication that the content item is associated with authorized or unauthorized access. The analysis device 107 may determine, from a plurality of identifiers encoded into the audio portion, a last device of the plurality of network devices to insert an identifier into the audio portion. The last device of the plurality of network devices to insert an identifier into the audio portion of the content item may be compared to one or more identifiers of a network device from which the analysis device 107 (e.g., or user device106) received the content item. For example, if an identifier determined in the content received by the analysis device 107 (e.g., or user device 106) does not match the one or more identifiers of a network device from which the content item was received, an indication may be generated and/or sent indicated unauthorized access to the content. In some scenarios, the sending the indication of an association of the network device with unauthorized access to the content item may further comprise sending, by the computing device, the indication of the unauthorized access to a digital rights management process of a content player of the computing device. It is contemplated that the actions of analysis device 107 as described in the forgoing paragraphs may be performed by a user device 106, content device 102, services device 108, or any other suitable device. It is contemplated that system 100 may be configured to perform the functions of the forgoing paragraphs for a plurality of devices accessing content.

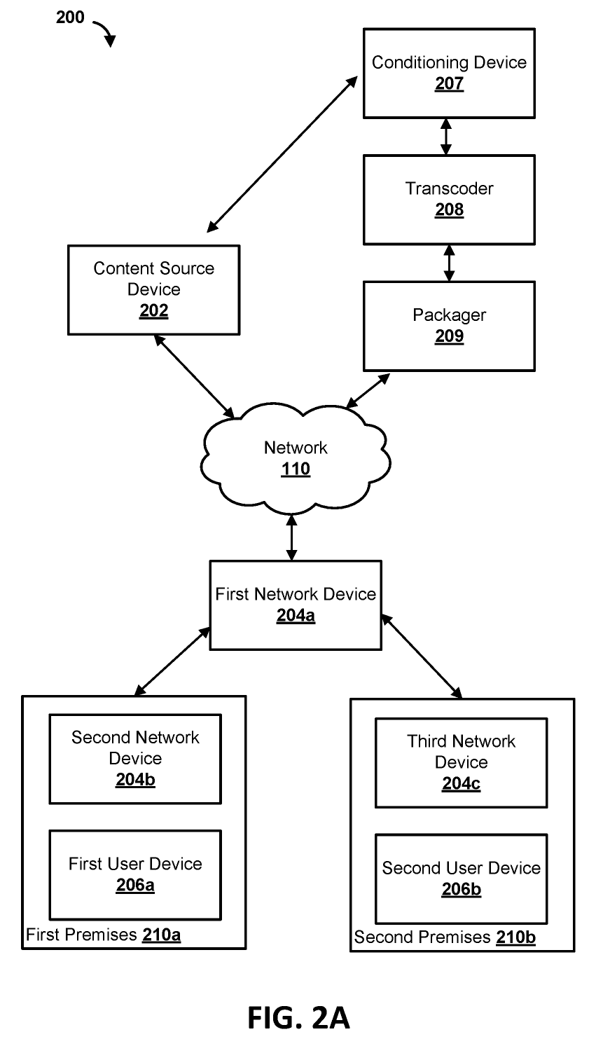

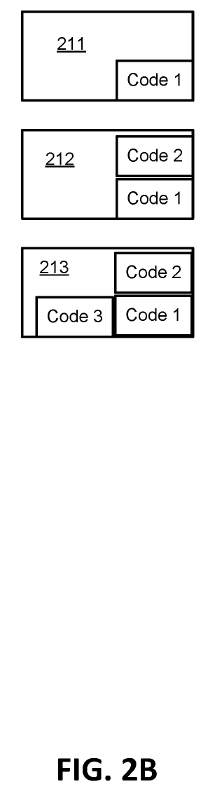

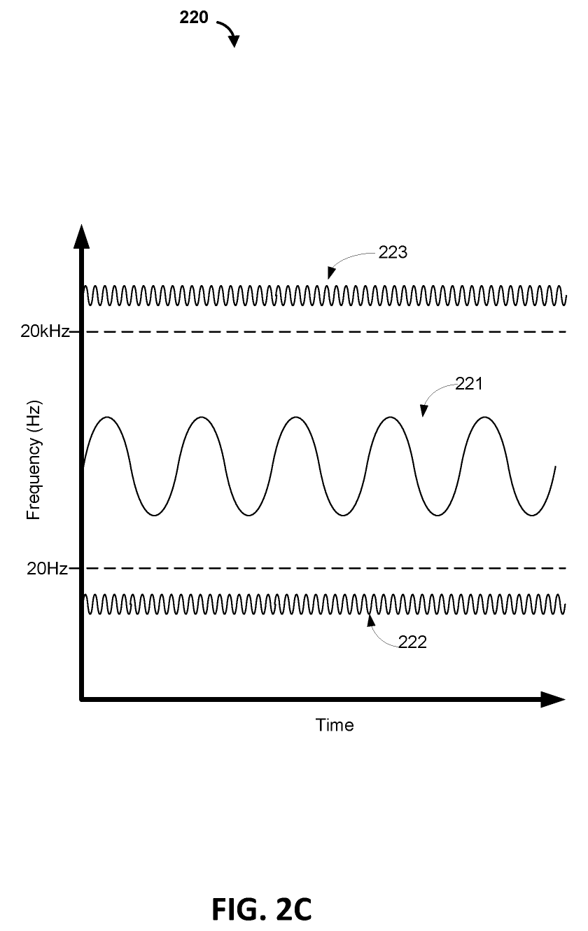

FIG. 2A shows a block diagram of an example system 200. The system 200 may comprise devices and features as described in FIG. 1, such as but not limited to a network 110, a user device 106 (e.g., first user device 206a, second user device 206b in FIG. 2A), a content device 102,105, and a network device 104 (e.g., first network device 204a, second network device 204b, and third network device 204c). The system 200 may comprise a content source device 202, a conditioning device 207, a transcoder 208, and a packager 209, and one or more premises 210a,b. The system 200 may comprise a first premises 210a and a second premises 210b. The first user device 206a and the second network device 204c may be located at the first premises 210a. the second user device 206b and the third network device 204c may be located at the second premises 210b.

The first premises 210a may be a customer premises. The first premises 210a may include an area within a coverage range (e.g., wireless range) of a corresponding network device, such as the second network device 204c. The first premises 210a may comprise a property, dwelling, terminal, building, floor, and/or the like. The first premises 210a may comprise different rooms, walls, door, windows, and/or the like. The one or more user devices (e.g., first user device 206a) may move within the premises which they are located at and/or move outside of the premises. The first user device 206a may be located at the first premises 210a.

The second premises 210b may be a customer premises. The second premises 210b may include an area within a coverage range (e.g., wireless range) of a corresponding network device, such as the third network device 204c. The second premises 210b may comprise a property, dwelling, terminal, building, floor, and/or the like. The second premises 210b may comprise different rooms, walls, door, windows, and/or the like. The one or more user devices (e.g., second user device 206b) may move within the premises which they are located at and/or move outside of the premises. The second user device 206b may be located at the second premises 210b.

The first user device 206a, and/or the second user device 206b may perform any of the features and/or operations described elsewhere herein, such as in the description corresponding to FIG. 1. The first user device 206a may receive a content item from the third network device 204c and output the content item as described elsewhere herein. The second user device 206b may receive a content item from the third network device 204c and output the content item as described elsewhere herein. The first user device 206a, and/or the second user device 206b may be configured to send an indication of an unauthorized access to the content item. The indication of the unauthorized access to the content item may be sent based on the determining the network device. The first user device 206a, and/or the second user device 206b may be configured to cause a user interface (e.g., user interface unit 114, or an interface of a piracy dashboard of a services provider) to receive the indication of the unauthorized access to the content item.

The plurality of network devices (e.g., first network device 204a, second network device 204b, or third network device 204c) may perform any of the features and/or operations described elsewhere herein, such as in the description corresponding to FIG. 1 (e.g., network device 104, services device 108, analysis device 107, etc.). The plurality of network devices 204a,b,c may be configured to receive a content item comprising an audio portion and a video portion. The audio portion may comprise a plurality of audio signals corresponding to a plurality of identifiers of a plurality of network devices of a content network. In some scenarios, the plurality of network devices 204a,b,c may be configured to determine that a user device (e.g., first user device 206a or second user device 206b) is authorized to access the content item.

The content source device 202, may perform any of the features and/or operations described elsewhere herein, such as in the description corresponding to FIG. 1 (e.g., content device 102,105). The content source device 202 may be configured to be the originating device for the content item being accessed or shared through the system 200. In some scenarios, the content source device 202 may be configured to communicate with any device of the system 200, such as but not limited to conditioning device 207 to provide data and information associated with the content item. The content source device 202 may encode (e.g., as one or more audio signals) information (e.g., an identifier of the content source device 202, other metadata) in the audio portion of the content item.

The conditioning device 207 may be configured to prepare the content item for distribution in the system 200. In some scenarios, the conditioning device 207 may perform functions such as signal processing, noise reduction, color correction, format conversion, or the like. The conditioning device 207 may be configured such that the content item may be utilized and read in downstream processes of the system 200. The conditioning device 207 may encode (e.g., as one or more audio signals) information (e.g., an identifier of the conditioning device 207, other metadata) in the audio portion of the content item. The conditioning device 207 may be configured to communicate (e.g., transmit) the content item to a transcoder 208 or another device in the system 200.

The transcoder 208 may be configured to convert the content item into one or more formats, resolutions, or bitrate versions. The transcoder 208 may be configured such that the conversion of the content item may enable the content item to be dynamically adjusted based on real-time network performance and device capabilities. The transcoder 208 may encode (e.g., as one or more audio signals) information (e.g., an identifier of the transcoder 208, other metadata) in the audio portion of the content item.

The packager 209 may be configured to wrap the transcoded content item to specific formats suitable for one or more computing devices. The packager 209 may encode, encrypt, or any other suitable method to protect the content from unauthorized access. The packager 209 may be configured to apply digital rights management to the content item. In some scenarios, the packager 209 may be configured to generate and encode metadata associated with the content item. Metadata may refer to information that describes and contextualizes the content. Metadata may provide additional details about the content item, making it easier to manage, search, and play back. Metadata may comprise any suitable data or information associated with the content item, such as but not limiting to, one or more of: a title, a description, a genre, a release date, a cast, a crew, a rating, a closed captions, playback duration, start time, end time, seek points, chapter markers, video format, resolution, bitrate, frame rate, codec, container format, or the like, or any combination thereof. Metadata may be encoded into the content item in any suitable binary format such as, XML (Extensible Markup Language), JSON (JavaScript Object Notation), ID3 tags, to ensure consistency and interoperability across different devices or platforms. The binary code of the metadata may store the textual information associated with the metadata as a series of 1’s and 0’s to facilitate storage, transmission, or processing of the content item by one or more devices. The packager 209 may encode (e.g., as one or more audio signals) information (e.g., an identifier of the packager 209, other metadata) in the audio portion of the content item.

As explained above, it is contemplated that the one or more devices of system 200 may be configured to encode one or more identifiers to the audio portion of the content item such that the transmission of the content item may be monitored. For example, an identifier may be added by each of the devices in the system if the content item arrives at the device. The identifiers of prior devices may remain in the content item, and the device receiving the content item may add a new identifier associated with the device (e.g., to identify the device) before transmitting the content item to another device. It is contemplated that at any device of the system 200 the device may analyze the audio portion of the content item to determine the authorization of the device receiving the content item.

In a scenario, a first entity may provide a content item to the system 200 via a content source device 202. The content item may be received by a content service entity configured to prepare the content item for distribution to one or more devices. The content service entity may, via a conditioning device 207, transcoder 208, or packager 209, adjust, encode, and/or convert the information associated with the content item to transmit to one or more devices associated with the system 200. The content service entity may transmit the content item to a first network device 204a to distribute to a first user associated with the first user device 206a. The first user device 204a may transmit the content item to a second network device 204b that may be associated with the first user device 206a. With each transmission of the content item to a device of system 200 an identifier may have been encoded to the audio signal portion of the content item. In some scenarios, the first user device 206a or second network device 204b may assess the one or more identifiers to determine the authorization of the user device receiving the content item.

The FIG. 2B shows a representation of a content item that may pass through the system of FIG. 2A. The FIG. 2B illustrates the addition of one or more identifiers associated with one or more encoded audio signals to a content item as the content item is transmitted to one device to the next of the system 200. For simplicity, the blocks 211, 212, and 213 may be the content item. The block 211 may be associated with the content item at a first network device, block 212 may be associated with the content item at a second network device, and the block 213 may be associated with the content item at a third network device. The content item at block 211 may be transmitted from the first network device to the second device, and from the second network device to the third network device. At each block associated with a network device, the FIG. 2B may illustrate a code (e.g., an encoded audio signal) being added to the audio portion of the content item. For example, the first network device may be a content source device 202.aThe first network device may encode an audio signal to the audio portion of the content item as illustrated in block 211 and code 1. The first network device may transmit the content item to a second network device, such as an analysis device 107. The second network device may be configured to add an encoded audio signal to the content item, as illustrated with block 212 comprising code 1 and code 2. The second network device may transmit the content item to a third network device such as a first network device 204a. The third network device may also be configured to insert one or more encoded audio signals to the content item received. The added encoded audio signal may be illustrated with the code 3 in block 213 associated with the audio portion of content. It is contemplated that the one or more audio signals inserted to the audio portion of the content item may be separate such that the information associated with each network device may be monitored and assess individually.

FIG. 2C may illustrate an example frequency vs. time graph associated with the audio portion 220 of a content item of block 212. The audio portion 220 may comprise an audio 221 associated with the content item and one or more encoded audio signals inserted via a plurality of network devices. The one or more encoded audio signals may be in a human inaudible range as illustrated by the FIG. 2C. A first network device may insert a first encoded audio signal 222 (e.g., code 1) to the audio portion 220 of the content item. A second network device may insert a second encoded audio signal 223 (e.g., code 2) to the audio portion 220 of the content item. For simplicity, the first encoded audio signal 222 and the second encoded audio signal 223 are illustrated to be the same length of the audio 221 of the content item. However, the first encoded audio signal 222 or the second encoded audio signal 223 may be of any variable length (e.g., seconds, milliseconds, or the like) that may be repeated along the length of the audio 221 associated with the content item. Conversely, the first encoded audio signal 222 or the second encoded audio signal 223 may be the same length of the audio 221 associated with the content item.

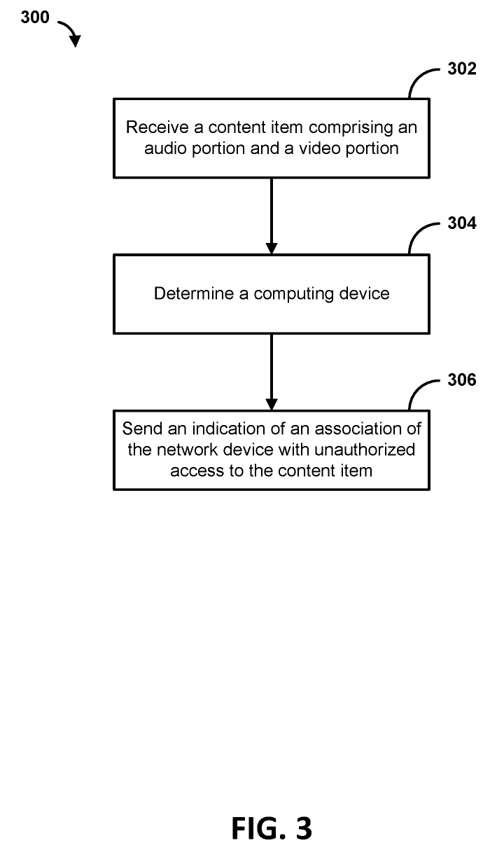

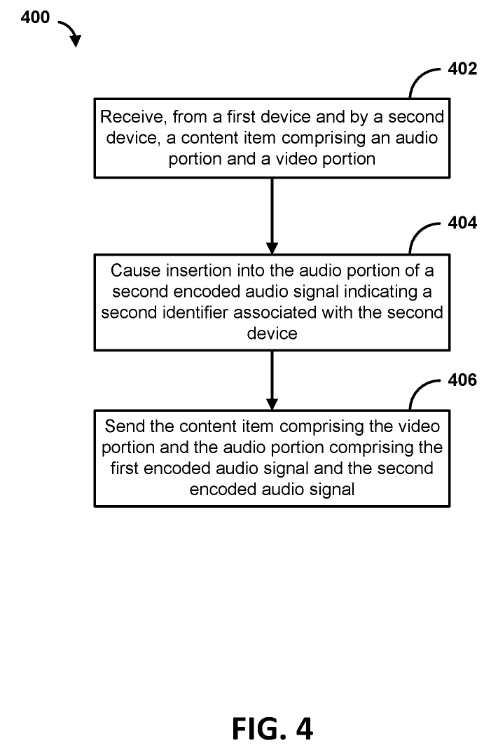

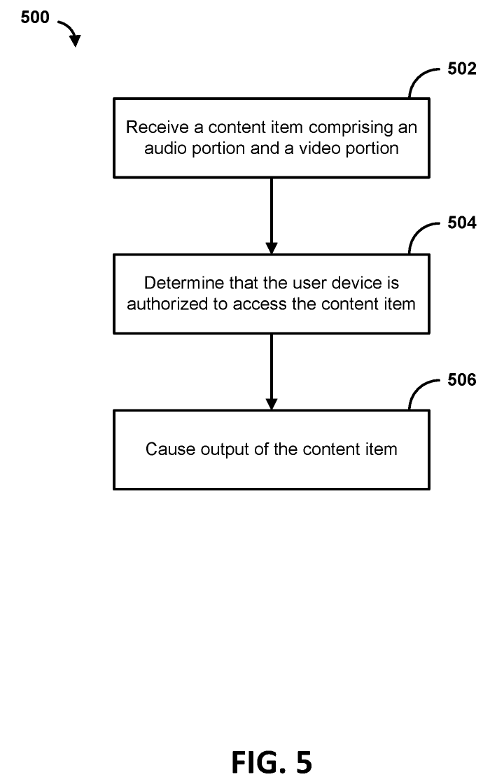

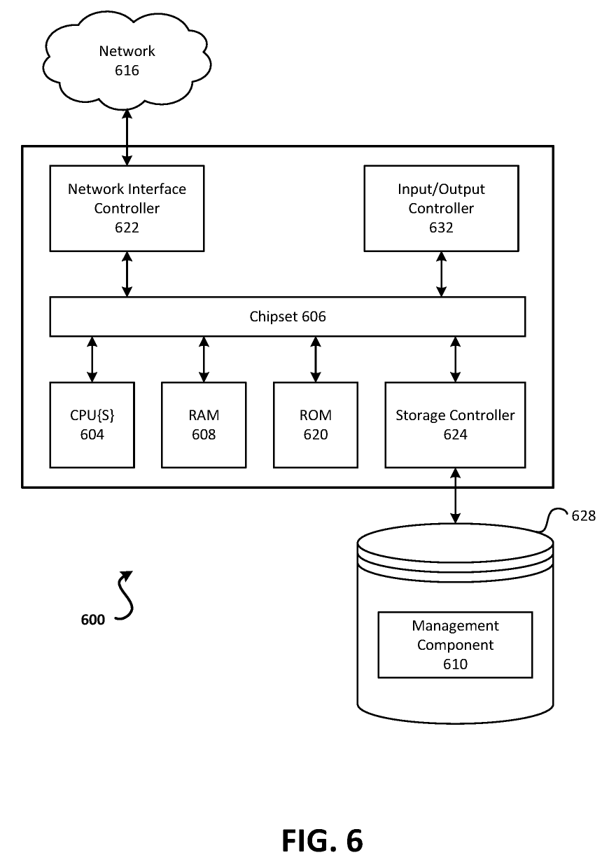

FIG. 3 shows an example method. The method 300 may comprise a computer implemented method for providing a service (e.g., a content service, a network service, a communication service, or a combination thereof). A system and/or computing environment, such as the system 100 of FIG. 1, FIGS. 2A-B , and/or the computing environment of FIG. 6, may be configured to perform the method 300. The method 300 may be performed in connection with the system illustrated in FIG. 1 or the systems illustrated in FIG. 2A. Any step or combination of steps of the method 300 may be performed by a computing device, network device, network node, and/or client device, such as any of the devices shown in FIG. 1 or FIG. 2A. Any of the features of the methods of FIGS. 4 and FIG. 5 may be combined with any of the features and/or steps of the method 300 of FIG. 3.

At step 302, a content item may be received. The content item may comprise an audio portion, a video portion, or a combination thereof. The video portion may comprise a plurality of frames associated with the content item. The audio portion may comprise a plurality of audio signals. The plurality of audio signals may correspond to a plurality of identifiers. The plurality of identifiers may be associated with a plurality of network devices of a content network (e.g., network 110). The plurality of network devices as described in the method 300 may comprise one or more of a content source device (e.g., content source device 202 ), a server device (e.g., services device 108), a conditioning device (e.g., conditioning device 207 ), a transcoder device (e.g., transcoder 208), a packager device (e.g., packager 209 ), an origin server, an encryption server, an edge cache device, a gateway device, a set top box device, a content streaming device, or a user device (e.g., user device 106).

At step 304, a computing device (e.g., or a network device) may be determined. The computing device may be determined based on the audio portion. The computing device may be determined based on analyzing the audio portion. The audio portion may comprise an encoded audio signal indicating an identifier associated with the computing device. Determining the computing device (e.g., by analyzing the audio portion) may comprise determining a location of the encoded audio signal in the audio portion. Determining the computing device may comprise decoding the audio signal to identify the identifier. The computing device may be determined based on a plurality of identifiers associated with the audio portion. For example, an audio portion may comprise an identifier. The identifier may correspond to a computing device of a plurality of computing devices. The computing device determined may be a last device (e.g., a network device) to insert an identifier into the audio portion associated with a content item. The encoded audio signal may be encoded in a frequency that is in a human inaudible frequency range. The human inaudible frequency range may refer to the audible frequency range that is outside of the range of human hearing, which may span from 20Hz to 20,000Hz. As such, the human inaudible frequency range may include audio frequencies below 20Hz and above 20,000 Hz. The embedded audio signal may be one or more of combined with original audio (e.g., in the audio portion) of the content item or a separate track that is to be output at the same time as the original audio. The term original in this context indicates the audio in the audio portion prior to insertion and/or embedding of the identifier in the audio portion.

At step 306, an indication of an association of the computing device with unauthorized access to the content item may be sent. The indication may be sent based on the determining the computing device associated with step 304. It is contemplated that the indication may be sent to any suitable device as illustrated in FIG. 1. Sending the indication may comprise causing a user interface, associated with an analysis device (e.g., analysis device 107). The user interface associated with the analysis device 107 may be configured to analyze unauthorized access to the content item. If it is determined that the computing device is unauthorized to access the content item, the analysis device 107 may receive the indication of the association of the computing device with unauthorized access to the content item.

In some scenarios, an analysis device (e.g., analysis device 107) may receive a content item. The content item may be a basketball game. The basketball game may comprise an audio portion and a video portion. The video portion may comprise a plurality of frames associated with the basketball game. The audio portion may comprise a plurality of audio signals. The plurality of audio signals may comprise two or more of: audio signals associated with audio of a basketball game, a plurality of identifiers, or the like. The plurality of identifiers may be associated with a plurality of computing devices (e.g., network devices) associated with a content network (e.g., network 110). The plurality of computing devices may comprise one or more of a content source device (e.g., first content device 102, second content device 105), a server device (e.g., services device 108), a content conditioning device, a transcoder device, a packager device, an origin server, an encryption server, an edge cache device, a gateway device, a set top box device, a content streaming device, or a user device.

The analysis device (e.g., analysis device 107) may determine a computing device (e.g., or user account) associated with the content item received. The computing device may be determined based on analyzing the plurality of audio signals associated with the basketball game (e.g., content item). The audio portion may comprise an encoded audio signal indicating an identifier associated with the computing device. Analyzing the plurality of audio signals may comprise determining a location of the encoded audio signal in the audio portion and decoding the encoded audio signal into the identifier. The audio portion may comprise a first identifier. The first identifier may correspond to a computing device of a plurality of computing devices, or potentially a user device (e.g., set top box, mobile device, streaming device). The computing device may be considered the last authorized device to receive the content item. The last device may be the last computing device to insert an identifier into the audio portion of associated with the content item (e.g., the basketball game). The first identifier may be an audio signal that is within a human inaudible frequency range, such as but not limited to, 15 Hz. For example, a user may access the basketball game via a set top box. The set top box may store a copy of the basketball game. The set top box may input an identifier of the user account of the user (e.g., or identifier of the user device) in the audio portion of the content item. The user may then send a copy of the stored basketball game to piracy server.

The analysis device 107 may receive the content item from an unauthorized based on scanning the piracy server. The analysis device (e.g., analysis device 107) may send an indication of an association of the set top box with unauthorized access to the content item. The analysis device 107 may send a notification to a user associated with the user account. The analysis device 107 may cause one or more actions, such as suspending the user account. The analysis device 107 may cause a user interface to receive the indication of the association of the second computing device with unauthorized access to the content item (e.g., basketball game).

FIG. 4 shows an example method. The method 400 may comprise a computer implemented method for providing a service (e.g., a content service, a network service, a communication service, or a combination thereof). A system and/or computing environment, such as the system 100 of FIG. 1, FIGS. 2A-B, and/or the computing environment of FIG. 6, may be configured to perform the method 400. The method 400 may be performed in connection with the system illustrated in FIG. 1 or the systems illustrated in FIG. 2A. Any step or combination of steps of the method 400 may be performed by a computing device, network device, network node, and/or client device, such as any of the devices shown in FIG. 1 or FIG. 2A. Any of the features of the methods of FIGS. 3 and FIG. 5 may be combined with any of the features and/or steps of the method 400 of FIG. 4.

At step 402, a content item may be received. The content item may comprise an audio portion, a video portion, or a combination thereof. The content item may be received from a first device and by a second device. The audio portion may comprise a plurality of audio signals corresponding to a plurality of identifiers of a plurality of network devices (e.g., or computing devices) associated with a content network (e.g., network 110). The audio portion associated with the content item received may comprise a first encoded audio signal. The first encoded audio signal may indicate a first identifier. The first encoded audio signal may be encoded using one or more frequencies in a human inaudible frequency range. The first identifier may be associated with the first device. The first audio signal may be utilized for one or more of: determining a sequence of network devices (e.g., or computing devices) receiving the content item, tracking a source of a violation of permissions associated with the content item, or the like.

At step 404, a second identifier associated with the second device may be caused to be inserted into the audio portion of a second encoded audio signal. The second encoded audio signal may indicate (e.g., correspond to) a second identifier associated with the second device. The second device may cause the insertion of the second identifier to the audio signal associated with the content item. The second encoded audio signal may indicate a second identifier. The second encoded audio signal may be encoded using one or more frequencies in a human inaudible frequency range. The second identifier may be associated with the second device. The audio portion may indicate that the first audio signal was inserted to the audio portion caused by a first device prior to the second encoded audio signal. The second audio signal may be utilized for one or more of: determining a sequence of network devices (e.g., or computing devices) receiving the content item, tracking a source of a violation of permissions associated with the content item, or the like. One or more of the first encoded audio signal or the second encoded audio signal may be one or more of combined with original audio of the content item or a separate track that is to be output at the same time as the original audio.

At step 406, the content item comprising the video portion and the audio portion comprising the first encoded audio signal and the second encoded audio signal may be sent. The content item comprising the video portion and the audio portion comprising the first encoded audio signal and the second encoded audio signal may be sent by the second device and to a third device. The first encoded audio signal and the second encoded audio signal may be encoded using one or more frequencies in a human inaudible frequency range. It is contemplated that one or more of the first device, the second device, or the third device may comprise one or more of a content source device (e.g., content source device 202), a server device (e.g., services device 108 ), a content distribution server, a content conditioning device (e.g., conditioning device 207 ), a transcoder device (e.g., transcoder 208), a packager device (e.g., packager 209), an origin server, an encryption server, an edge cache device, a gateway device, a set top box device, a content streaming device, or a user device (e.g., user device 106 ). The audio portion associated with the content item received may indicate an order associated with the insertion of one or more one or more encoded audio signals associated with one or more devices.

FIG. 5 shows an example method. The method 500 may comprise a computer implemented method for providing a service (e.g., a content service, a network service, a communication service, or a combination thereof). A system and/or computing environment, such as the system 100 of FIG. 1, FIG. 2A, and/or the computing environment of FIG. 6, may be configured to perform the method 500. The method 500 may be performed in connection with the system illustrated in FIG. 1 or the systems illustrated in FIG. 2. Any step or combination of steps of the method 500 may be performed by a computing device, network device, network node, and/or client device, such as any of the devices shown in FIG. 1 or FIG. 2A. Any of the features of the methods of FIGS. 3 and FIG. 4 may be combined with any of the features and/or steps of the method 500 of FIG. 5.

At step 502, a content item may be received, such as via a user device (e.g., the user device 106 of FIG. 1). The content item may comprise an audio portion and a video portion. The audio portion may comprise one or more audio signals. The one or more audio signals may encode a plurality of identifiers. The one or more audio signal encodings may encode the audio signal using one or more frequencies in a human inaudible frequency range. The one or more audio signals may be one or more of combined with original audio of the content item or a separate track that is to be output at the same time as the original audio The one or more encoded audio signals may be associated with a plurality of identifiers. The plurality of identifiers may be associated with a plurality of network devices (e.g., or computing devices) of a content network (e.g., network 110). The plurality of network devices may have received the content item prior to the user device receiving the content item. Each of the plurality of network devices may have caused the encoding of one or more audio signals utilizing one or more frequencies in a human inaudible frequency range. The plurality of network devices may comprise one or more of a content source device, a server device, a content distribution server, a content conditioning device, a transcoder device, a packager device, an origin server, an encryption server, an edge cache device, a gateway device, a set top box device, or a content streaming device. In some scenarios, the audio portion may comprise encoded metadata associated with the content item. In such scenarios, the method 400 may comprise decoding the encoded metadata. The decoded meta data may be utilized to provide one or more services or information associated with the content item.

At step 504, a determination may be made that a user device is authorized to access the content item. The determination may be made by a user device, such as by user device 106 of FIG. 1. The determination may be based on at least a portion of the one or more audio signal encodings associated with a plurality of identifiers. The determination may comprise determining a last device of a plurality of network devices to insert an identifier into the audio portion. The last device may be determined from based on determining the last identifier of a plurality of identifiers encoded into the audio portion. The determination may further comprise comparing the last identifier associated with the last device to an identifier of a network device (e.g., or computing device) from which the user device received the content item.

At step 506, output of the content item may be caused. The output of the content item may be caused by the user device. The output of the content item may be caused based on the determining that the user device is authorized to access the content item, as described in step 504. In some scenarios, step 506 may further comprise sending the content item and an indication of a lack of authorization to a computing device configured to analyze unauthorized access. In such scenarios, step 506 may instead include determining that the user device is unauthorized to access the content item. The user device may be determined to be unauthorized to access the content item based on the comparison of the identifier associated with the last device encoded in the content item to an identifier of a network device (e.g., or computing device) associated with the user device that received the content item. For example, if the identifier associated with the last device does not match the identifier of the network device (e.g., or computing device) associated with the user device that received the content item, then the user device may be determined to be unauthorized to access the content item.

FIG. 6 depicts a computing device that may be used in various aspects, such as the servers, modules, and/or devices depicted in FIG. 1 and FIG. 2. With regard to the example architecture of FIG. 1, the one or more content devices (e.g., first content device 102, second content device 105), the network device 104, the user device 106, the analysis device 107, services device 108, and any devices of network 110 may be each be implemented in an instance of a computing device 600 of FIG. 6. With regard to the system of FIG. 2A, the content source device 202, the conditioning device 207, the transcoder 208, the packager 209, the first network device 204, the second network device 204b, the third network device 204c, the first user device 206a, and/or the second user device 206b may be each be implemented in an instance of a computing device 600 of FIG. 6. The computer architecture shown in FIG. 6 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 1, FIGS. 2A-C, FIG. 3, FIG. 4, and FIG. 5.

The computing device 600 may include a baseboard, or “motherboard,” which is a printed circuit board to which a multitude of components or devices may be connected by way of a system bus or other electrical communication paths. One or more central processing units (CPUs) 604 may operate in conjunction with a chipset 606. The CPU(s) 604 may be standard programmable processors that perform arithmetic and logical operations necessary for the operation of the computing device 600.

The CPU(s) 604 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 604 may be augmented with or replaced by other processing units, such as GPU(s) 605. The GPU(s) 605 may comprise processing units specialized for but not necessarily limited to highly parallel computations, such as graphics and other visualization-related processing.

A chipset 606 may provide an interface between the CPU(s) 604 and the remainder of the components and devices on the baseboard. The chipset 606 may provide an interface to a random-access memory (RAM) 608 used as the main memory in the computing device 600. The chipset 606 may further provide an interface to a computer-readable storage medium, such as a read-only memory (ROM) 620 or non-volatile RAM (NVRAM) (not shown), for storing basic routines that may help to start up the computing device 600 and to transfer information between the various components and devices. ROM 620 or NVRAM may also store other software components necessary for the operation of the computing device 600 in accordance with the aspects described herein.

The computing device 600 may operate in a networked environment using logical connections to remote computing nodes and computer systems through local area network (LAN) 616. The chipset 606 may include functionality for providing network connectivity through a network interface controller (NIC) 622, such as a gigabit Ethernet adapter. A NIC 622 may be capable of connecting the computing device 600 to other computing nodes over a network 616. It should be appreciated that multiple NICs 622 may be present in the computing device 600, connecting the computing device to other types of networks and remote computer systems.

The computing device 600 may be connected to a mass storage device 628 that provides non-volatile storage for the computer. The mass storage device 628 may store system programs, application programs, other program modules, and data, which have been described in greater detail herein. The mass storage device 628 may be connected to the computing device 600 through a storage controller 624 connected to the chipset 606. The mass storage device 628 may consist of one or more physical storage units. A storage controller 624 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 600 may store data on a mass storage device 628 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 628 is characterized as primary or secondary storage and the like.

For example, the computing device 600 may store information to the mass storage device 628 by issuing instructions through a storage controller 624 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 may further read information from the mass storage device 628 by detecting the physical states or characteristics of one or more particular locations within the physical storage units.

In addition to the mass storage device 628 described above, the computing device 600 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 600.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 628 depicted in FIG. 6, may store an operating system utilized to control the operation of the computing device 600. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 628 may store other system or application programs and data utilized by the computing device 600.

The mass storage device 628 or other computer-readable storage media may also be encoded with computer-executable instructions, which, when loaded into the computing device 600, transforms the computing device from a general-purpose computing system into a special-purpose computer capable of implementing the aspects described herein. These computer-executable instructions transform the computing device 600 by specifying how the CPU(s) 604 transition between states, as described above. The computing device 600 may have access to computer-readable storage media storing computer-executable instructions, which, when executed by the computing device 600, may perform the methods described in relation to FIG. 1, FIG. 2, FIG. 3, FIG. 4, and FIG. 5.

A computing device, such as the computing device 600 depicted in FIG. 6, may also include an input/output controller 632 for receiving and processing input from a number of input devices, such as a keyboard, a mouse, a touchpad, a touch screen, an electronic stylus, or other type of input device. Similarly, an input/output controller 632 may provide output to a display, such as a computer monitor, a flat-panel display, a digital projector, a printer, a plotter, or other type of output device. It will be appreciated that the computing device 600 may not include all of the components shown in FIG. 6, may include other components that are not explicitly shown in FIG. 6, or may utilize an architecture completely different than that shown in FIG. 6.

As described herein, a computing device may be a physical computing device, such as the computing device 600 of FIG. 6. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

The term “or” when used with “one or more of” is used in its inclusive sense (and not in its exclusive sense) so that when used, for example, to connect a list of elements, the term “or” means one, some or all of the elements in the list. The term “or” when used with “at least one of” is used in its inclusive sense (and not in its exclusive sense) so that when used, for example, to connect a list of elements, the term “or” means one, some or all of the elements in the list. For example, the phrases “one or more of A, B, or C” includes any of the following: A, B, C, A and B, A and C, B and C, and A and B and C. Similarly, the phrase “one or more of A, B, and C” includes any of the following: A, B, C, A and B, A and C, B and C, and A and B and C. The phrase “at least one of A, B, or C” includes any of following: A, B, C, A and B, A and C, B and C, and A and B and C. Similarly, the phrase “at least one of A, B, and C” includes any of following: A, B, C, A and B, A and C, B and C, and A and B and C.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some, or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is Claimed:

1. A method comprising:
receiving a content item comprising an audio portion and a video portion;
determining, based on the audio portion, a computing device, wherein the audio portion comprises an encoded audio signal indicating an identifier associated with the computing device, wherein the encoded audio signal is encoded using a frequency in a human inaudible frequency range; and
sending, based on the determining the computing device, an indication of an association of the computing device with unauthorized access to the content item.

2. The method of claim 1, wherein the encoded audio signal is one or more of combined with original audio of the content item or a separate track that is to be output at the same time as the original audio.

3. The method of claim 1, wherein the audio portion comprises a plurality of audio signals corresponding to a plurality of identifiers of a plurality of computing devices of a content network.

4. The method of claim 1, wherein determining the computing device comprises determining, from among a plurality of identifiers encoded into the audio portion, a last device to insert an identifier into the audio portion.

5. The method of claim 1, wherein the computing device comprises one or more of a content source device, a server device, a content distribution server, a content conditioning device, a transcoder device, a packager device, an origin server, an encryption server, an edge cache device, a gateway device, a set top box device, a content streaming device, or a user device.

6. The method of claim 1, wherein determining, based on the audio portion, the computing device comprises determining a location of the encoded audio signal in the audio portion and decoding the encoded audio signal into the identifier.

7. The method of claim 1, wherein sending the indication of the association of the computing device with unauthorized access to the content item comprises causing a user interface configured to analyze unauthorized access to content to receive the indication of the association of the computing device with unauthorized access to the content item.

8. A method comprising:
receiving, from a first device and by a second device, a content item comprising an audio portion and a video portion, wherein the audio portion comprises a first encoded audio signal indicating a first identifier associated with the first device;
causing, by the second device, insertion into the audio portion of a second encoded audio signal indicating a second identifier associated with the second device, wherein the first encoded audio signal and the second encoded audio signal are encoded using one or more frequencies in a human inaudible frequency range; and
sending, by the second device and to a third device, the content item comprising the video portion and the audio portion comprising the first encoded audio signal and the second encoded audio signal.

9. The method of claim 8, wherein one or more of the first encoded audio signal or the second encoded audio signal is one or more of combined with original audio of the content item or a separate track that is to be output at the same time as the original audio.

10. The method of claim 8, wherein the audio portion comprises a plurality of audio signals corresponding to a plurality of identifiers of a plurality of computing devices of a content network.

11. The method of claim 8, wherein determining the computing device comprises determining, from among a plurality of identifiers encoded into the audio portion, a last device to insert an identifier into audio portion.

12. The method of claim 8, wherein one or more of the first device, the second device, or the third device comprises one or more of a content source device, a server device, a content distribution server, a content conditioning device, a transcoder device, a packager device, an origin server, an encryption server, an edge cache device, a gateway device, a set top box device, a content streaming device, or a user device.

13. The method of claim 8, wherein the audio portion indicates that the first encoded audio signal was inserted prior to the second encoded audio signal.

14. The method of claim 8, wherein the first encoded audio signal and the second encoded audio signal are used for one or more: determining a sequence of computing devices receiving the content item in a content network, or tracing a source of a violation of permissions associated with the content item.

15. A method comprising:
receiving, by a user device, a content item comprising an audio portion and a video portion, wherein the audio portion comprises one or more audio signals encoding a plurality of identifiers of a plurality of computing devices of a content network that received the content item prior to the user device, wherein the one or more audio signal encodings are encoded using one or more frequencies in a human inaudible frequency range;
determining, by the user device and based on at least a portion of the one or more audio signal encodings, that the user device is authorized to access the content item; and
causing, based on the determining that the user device is authorized to access the content item, output of the content item.

16. The method of claim 15, wherein the one or more audio signals are one or more of combined with original audio of the content item or a separate track that is to be output at the same time as the original audio.

17. The method of claim 15, wherein determining that the user device is authorized to access the content item comprises determining, from among the plurality of identifiers encoded into the audio portion, a last device of the plurality of computing devices to insert an identifier into the audio portion and comparing the identifier of the last device to an identifier of a computing device from which the user device received the content item.

18. The method of claim 15, wherein the plurality of computing devices comprises one or more of a content source device, a server device, a content distribution server, a content conditioning device, a transcoder device, a packager device, an origin server, an encryption server, an edge cache device, a gateway device, a set top box device, or a content streaming device.

19. The method of claim 15, further comprising sending the content item and an indication of a lack of authorization to a computing device configured to analyze unauthorized content access.

20. The method of claim 15, wherein the audio portion comprise encoded metadata associated with the content item, and further comprising decoding the encoded metadata and using the decoded metadata to provide one or more of services or information associated with the content item.
